(19) United States
(12) Patent Application Publication
(10) Pub. No.: US 2023/0418114 A1
(43) Pub. Date: Dec. 28, 2023

(54) LIQUID CRYSTAL OPTICAL ARRANGEMENT FOR CONTROLLABLY OBSCURING A PORTION OF A FIELD OF VIEW

(71) Applicant: UNIVERSITÉ LAVAL, Québec (CA)

(72) Inventor: Tigran GALSTIAN, Québec (CA)

(21) Appl. No.: 18/042,245

(22) PCT Filed: Aug. 23, 2021
(86) PCT No.: PCT/CA2021/051164

§ 371 Date: Feb. 20, 2023

Related U.S. Application Data
(60) Provisional application No. 63/211,317, filed on Jun. 16, 2021.
(60) Provisional application No. 63/068,731, filed on Aug. 21, 2020.

(51) Int. Cl. G02F 1/1343; G02F 1/29; G02F 1/1335; G02F 1/13363; F21S 41/64; B60Q 1/14

(52) U.S. Cl. CPC G02F 1/134309; G02F 1/292; G02F 1/294; G02F 1/133553; G02F 1/133638; F21S 41/645; B60Q 1/143; G02F 2203/24

(57) ABSTRACT

Liquid crystal optical devices are disclosed that allow for dynamic light modulation to be selectively controlled within a portion of an aperture of the liquid crystal modulator and/or that have an improved spatial modulation of the electric field using electrodes causing light within the portion of the aperture to be diverted from a collimated beam and thus appear to be obscured or darkened in the projected beam or in a received beam.

This patent application claims priority under 35 USC § 119(e) of U.S. patent applications 63/068,731 filed Aug. 21, 2020 and 63/211,317 filed Jun. 16, 2021, the contents of which are hereby incorporated by reference. This application is related to Applicant's International PCT patent application PCT/CA2020/051688 filed on Dec. 8, 2020, designating the United States, the contents of which are hereby incorporated by reference.

### TECHNICAL FIELD

The present patent application relates to liquid crystal optical devices.

### BACKGROUND

Creating dynamic (time variable) images by light patterning is widely used in many photonic devices of our day-to-day life. The most straightforward way of performing such patterning is the use of light blocking devices, such as spatial light modulators (SLMs) or liquid crystal (LC) displays (LCDs). One major problem with this approach is the need of using polarization filters, which introduce dramatic losses even in the “transmissive” state of the device. The current invention proposes an alternative way of creating dynamic light patterns (e.g., to create dark zones), without the use of polarization filters. The core of the technology is based on the use of an electrically variable gradient index structure combined with a fixed lens structure.

Liquid crystal optical devices are known in the art that dynamically modulate beams. For example, PCT patent application publication WO2017/040067, published on 16 Mar. 2017, describes a variety of optical arrangements including liquid crystal devices that will broaden a beam. In PCT patent application publication WO2016/082031, published on 2 Jun. 2016, a variety of optical arrangements including liquid crystal devices are described for steering a beam. And in PCT patent application publication WO2018/152644, published on 30 Aug. 2018, a variety of optical arrangements including liquid crystal devices are described for modulating a headlight beam. These devices are all arranged to act on a whole beam.

Sharing a common priority date with the present application and disclosing further liquid crystal devices able to form lenses within a portion of a beam is Applicant's published PCT patent application WO 2021/113963 published on Jun. 17, 2021.

### SUMMARY

Applicant has found that there is a need to controllably modulate a portion of a beam so as to reduce the brightness in the portion, while leaving a remainder of the same beam unmodulated. Such a need existing both for beam transmission as well as for receiving or for projecting a beam of light. By “portion of a beam” and “unmodulated”, it is to be understood that the novel devices described herein are different from pixel-based display modulators that modulate light on the basis of individual pixels, and do not leave regions or portions of a beam passing through an aperture of the device unmodulated.

Applicant has discovered that dynamic light patterns may be generated without blocking light (reflection or absorption) by polarization filters. Instead, the applicant proposes the use of electrically tunable refractive index (or phase) modulation devices that are combined with fixed optical structures to perform dynamic angular redistribution of light's energy that allows creating low intensity angular zones, or dark zones.

To perform this in an effective way, the applicant has discovered a new way of creating dynamically variable gradient index devices (lens, prisms, etc.).

Applicant has found that there is a need to controllably modulate a portion of a beam so as to reduce the light brightness in the portion (in a specific angular range), while leaving a remainder of the same beam unmodulated. Such a need existing both for beam transmission (e.g., in automotive industry for safe driving) as well as for receiving or collecting a beam of light (in Lidars, sensors of simply in photographic imaging).

Liquid crystal optical devices are disclosed that allow for light modulation to be selectively controlled within a portion of an aperture of the liquid crystal modulator and/or that have an improved spatial modulation of the electric field using electrodes that provide shifted or decaying voltages.

It will also be appreciated that in some embodiment of the proposed solution, a device composed of an electrically tunable optical component used to control light propagation by focusing, broadening, stretching or steering, can be combined with a device as proposed herein to control the edges of the transmitted beam. For lighting, this can be used to provide a dynamically variable intensity profile to a beam, in particular to the edge or edges of a beam. In the case of a camera, such a device can be used as a diaphragm.

In other embodiment, a device can be composed of multiple individually controllable linear or circular segments of any type of refractive device combined with secondary diverting optics as described herein to generate a gradual diaphragming function without the use of mechanical obturators.

In some embodiments, there is provided a liquid crystal optical device for controllably obscuring a portion of a field of view without light absorption. The device may comprise an electrode array having distinct spatially arranged electrodes for controlling liquid crystal orientation differently at selected or different locations over an aperture of said device. In this way, when the electrode array is operative to cause the device to change from a transparent uniform state to a transparent nonuniform state diverting light state at the selected or different location within or over an aperture of the device. A controller can be connected to the electrode array and be configured to switch power to the electrode array in accordance with an input signal selecting one or more given ones of the selected or different locations over the aperture of the device.

The device may further comprise an optical element redirecting energy of the diverted light into different directions. The device may comprise at least one layer of liquid crystal material and the electrode array may be arranged to act on the at least one layer to focus light passing through the desired location in the transverse plane. The electrode array may comprise serpentine electrodes.

The controller may be configured to switch power to more than one of the different locations over the aperture of the device.

The electrode array may be configured to provide a segmented Fresnel lens or beam steering arrangement of the liquid crystal. The device as defined may comprise a mirror for reflecting light passing through the liquid crystal and a quarter wave plate that rotates the linear polarization of light by 90° after reflection by the mirror.

The device can comprise two similar liquid crystal cells assembled with 90° rotation of their ground state molecular orientations to provide polarization independent operation.

In some embodiments, there is provided an optical arrangement for controllably obscuring a portion of a field of view, the arrangement comprising a liquid crystal optical device as described above and an imaging lens. In some embodiments, there is provided a controllable light projector for producing a light beam with a controllable obscured portion of the light beam, the projector comprising a light source and the optical arrangement. In some embodiments, there is provided a light sensing or recording apparatus for sensing light from a field of view with a controllable obscured portion of the field of view, the apparatus comprising the optical arrangement and a light sensor operatively coupled to the optical arrangement for receiving light from the field of view.

In some embodiments, there is provided a method for sensing light from a field of view, the method comprising optically collecting a beam of light from the field of view, capturing the beam on an image sensor at an image plane, measuring a brightness of light at different locations within the image plane, determining which portion within the image plane requires obscuring, and using a liquid crystal optical device for controllably obscuring the portion.

### BRIEF DESCRIPTION OF THE DRAWINGS

The invention will be better understood by way of the following detailed description of embodiments of the invention with reference to the appended drawings, in which:

FIG. 1a schematically shows a basic device enabling the generation of dark zones (dip of light power) on the transmitted beam's transversal distribution by the formation of refractive index modulation in specific areas of interest of the matrix lens.

FIG. 1b schematically shows the device of FIG. 1a and the segment of interest (in the matrix lens) in its ground (non excited) state providing the original light distribution.

FIG. 1c schematically shows the device of FIG. 1a and the segment of interest (in the matrix lens) in the excited state providing the light redistribution with the dip of intensity (the dark window or zone of desired shape).

FIG. 2a schematically shows a top substrate with linear individually controlled discrete electrodes.

FIG. 2b schematically shows a bottom substrate with a uniform transparent electrode.

FIG. 2c schematically shows (top view) a combination of top (FIG. 2a) and bottom (FIG. 2b) substrate to form an LC cell with the capability of creating local excitation zones.

FIG. 2d schematically shows (side view) a combination of top (FIG. 2a) and bottom (FIG. 2b) substrate to form an LC cell with the capability of creating local excitation zones.

FIG. 2e schematically shows (side view) a possible variation of the device of FIG. 2d when the top substrate contains also a weakly conductive layer.

FIG. 2f schematically shows (side view) a possible variation of the device of FIG. 2d when the top substrate contains also a uniform transparent electrode that is separated from the original linear electrodes by a preferably thin dielectric isolation layer to provide accelerated operation mode.

FIG. 3a schematically shows a bottom substrate with linear individually controlled discrete electrodes oriented at 90 degrees with respect to the electrodes described in FIG. 2a.

FIG. 3b schematically shows (top view) a combination of top (FIG. 2a) and bottom (FIG. 3a) substrates to form an LC cell with the capability of creating local excitation zones.

FIG. 3c illustrates a schematic of a linear serpentine electrode from a first substrate of an LC cell allowing the generation of a lens with different apertures (diameters) and positions (centers) having two similar substrates with multiple electrode contacts (juxtaposition of multiple similar patterns) in accordance with one embodiment of the present invention.

FIG. 4a schematically shows the combination of two identical sandwiches with the ground state molecular orientations of LCs being perpendicular.

FIG. 4b schematically shows the combination of two identical sandwiches with the same orientation of LCs but with a polarization rotation element (e.g., a half wave plate or HWP).

FIG. 5a schematically shows the combination of the above-mentioned dark zone generation device combined with a light source, a primary light-conditioning (e.g., collimating) optics and a diaphragm.

FIG. 5b schematically shows the combination of the above-mentioned dark zone generation device combined with a light detection unit and an undesired bright (intense) light source.

FIG. 5c schematically shows the combination of the above-mentioned dark zone generation device combined with multiple light sources and along with multiple primary light-conditioning (e.g., collimating) optics.

FIG. 5d schematically shows the combination of the device of FIG. 5a combined with an electrically tunable lens or lens array.

FIG. 5e is a composite illustration of examples of complex light intensity distributions that may result from the use of an LC device as presented in FIGS. 5a to 5d.

FIG. 5f schematically shows the combination of the dark zone LC device in a tunable mirror lens device combined with an imaging lens.

FIG. 5g is an exemplary light intensity distribution of a dark zone LC device in combination with a beam broadening device, resulting in sharper broadened edges.

FIG. 5h is an exemplary light intensity distribution of a dark zone LC device in combination with a beam steering device, resulting in sharper steered edges.

FIG. 5i is an exemplary light intensity distribution of a dark zone LC device in combination with a Fresnel lens providing dynamic diaphragming.

FIG. 6a schematically shows the automotive application of the described-above devices when multiple (co- and counter-propagating) cars are present on the road.

FIG. 6b is a schematic block diagram of a vehicle headlight control system equipped with dark zone LC devices.

FIG. 7a schematically shows the sensing application of the described-above devices when multiple (including one undesired powerful) sources are present on the screen.

FIG. 7b schematically shows the image capturing application of the described-above devices when a powerful local light source is present on the screen.

FIG. 8a schematically shows the generation of a horizontal dark line.

FIG. 8b schematically shows the generation of a circular dark zone.

FIG. 8c schematically shows the simultaneous generation of a circular dark zone and a vertical dark line.

FIG. 9a shows the simulation results for an unperturbed light beam with approximately gaussian shaped intensity (transversal) distribution.

FIG. 9b shows the simulation results for the dynamic creation of a narrow dark line passing through the center of the light beam.

FIG. 9c shows the numerical values obtained for the case demonstrated in FIG. 9b.

FIGS. 10a, 10b and 10c illustrate the simulated beam intensity in the Y axis at screen distances of 1.5 m, 3.5 m and 5.0 m respectively.

FIGS. 11a to 11d show how the choice of the diameter (0.05 mm, 0.25 mm and 0.5 mm for FIGS. 11A to 11C respectively) of the activated cylindrical microlens of the matrix lens can affect the dark zone.

FIGS. 12a to 12c illustrate on the left side the beam intensity image and on the right side the corresponding beam intensity along the Y axis for the case of the focal distance of the microlens chosen to be −2.0 mm, −5.0 mm and −0.5 mm, respectively.

FIGS. 13a to 13c illustrate plots of the light distribution pattern for the choice of the focal distance (−50 mm, 50 mm and 75 mm, respectively) of the imaging lens.

FIG. 14 is a block diagram of an example of the dark zone generating tunable matrix device having controllers for strip electrodes.

FIG. 15 is an illustration of an optical arrangement including a matrix element, an imaging lens and a screen.

FIG. 16a shows an experimentally obtained image of the transmitted beam in the ground state of the tunable lens (0V).

FIG. 16b shows the image of the beam when a cylindrical lens is generated at 10V.

FIG. 16c shows the intensity distribution across the beam on the screen versus applied voltages.

FIGS. 17a to 17f show experimentally obtained images using two simultaneously generated cylindrical micro lenses that generate two dark zones in corresponding angular zones with electrically tunable properties.

### DETAILED DESCRIPTION

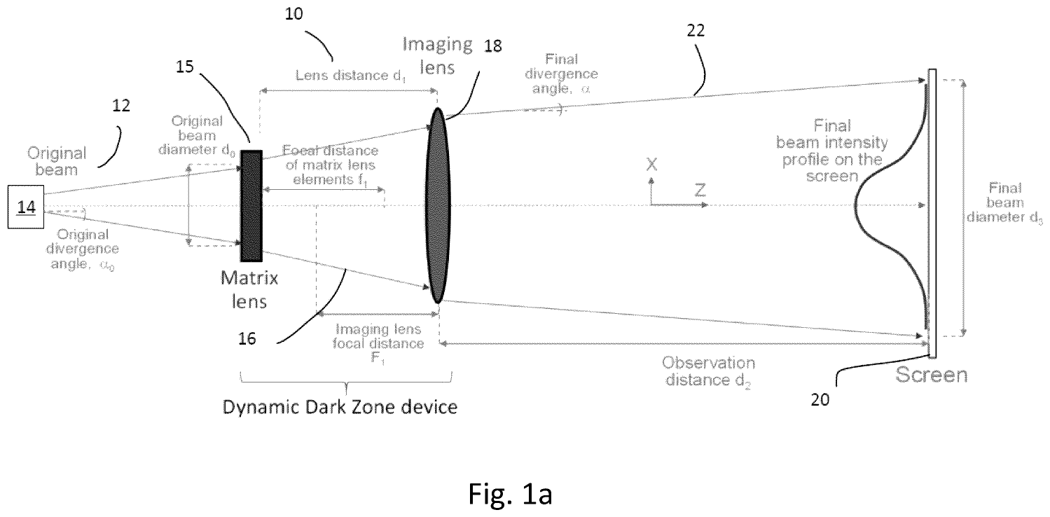

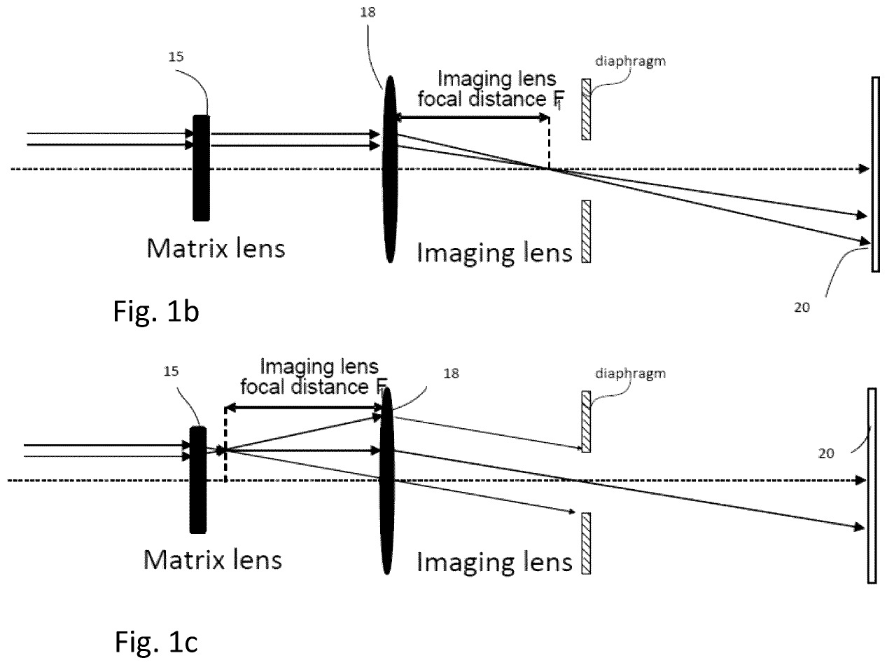

The combination of an element capable of creating localized refractive index gradients (e.g., a matrix modulator device as described above) with an “imaging” optical lens (optionally with a stop or diaphragm) can enable the control of angular distribution of the transmitted light. Thus, in the embodiment of FIG. 1a, an optical arrangement 10 receives an original beam 12 from a light source 14 that passes through a matrix beam modulator 15 followed by an imaging lens 18 to produce a beam 22 projected onto a screen 20. The matrix modulator 15 can be a suitable LC device. Device 15 can be electrically controlled to alter portions of the original beam 12 crossing specific zones of the device 15 in its transverse plane. In the illustration of FIG. 1a, the device 15 is not activated and thus the beam 16, leaving device 15, is not modulated and the resulting beam 22 has a final beam intensity on the screen 20 that shows a Gaussian distribution (as an example). The selected portion or portions of the beam 12 that can be dynamically controlled can be specific selected portions of the beam 12 or it can be any desired portion of the beam in accordance with the electrode arrangement in device 15.

For example, device 15 may have a substrate with an array of controlled electrodes (e.g., along the x axis) covering its entire aperture as it is well-known in traditional “in-plane-switch” displays with LC material placed between such substrates, the LC material being aligned homeotropically or planar, for example. Device 15 may alternatively consist of polymer dispersed LC (PDLCs) device, or it may comprise one or more layers of LC and have hole-patterned electrodes. For example, whole patterned electrodes can be powered to create an array of micro lenses that will actively cause light passing through the LC to be diverted and thus diffused. Other electrode structures, such as a serpentine electrode structure presented herein, may be used (e.g. to create a lens with desired properties at a desired location, to create a cylindrical lens in a desired region, a prism, etc.). Alternatively, strip electrodes may be provided for the purposes of creating micro cylindrical lenses that can likewise be selectively activated for diverting light as desired. Such micro-lenses may have an ability to focus or defocus light or they may simply redirect or scatter light without focusing.

As illustrated in FIG. 1b, the above-mentioned matrix modulator 15 can comprise a matrix lens. In this Figure, the matrix lens 15 is not powered, and the portion (or the “zone of interest”) of the beam (shown by a couple of solid horizontal arrows on the top left part) passing through the matrix lens 15 is then focused by the imaging lens 18 to provide a spot on screen 20. In the case of FIG. 1c, the matrix lens is activated for the portion of the beam (the “zone of interest”) and light passing through this zone is focused causing it to diverge when reaching lens 18 with the result that the light from the portion of the matrix lands arrives at screen 20 in a broadened fashion. Thus, we obtain an intensity modulation by the angular redistribution of energy and without the use of polarizers that are traditionally used in display type solutions.

Obviously, various zones or segments of the matrix device 15 may be activated simultaneously or sequentially to create different (desired) light modulation profiles on the screen.

It will be appreciated also that the use of a separate imaging lens 18 in combination with the matrix modulator 15 is optional depending on the optical arrangement. For example, the imaging lens or micro lenses may be integrated into the exit substrate of the device 15. Likewise, the matching of the focal distances between a matrix lens 15 and the focal distance of an imaging lens 18, while able to improve the contrast or the loss of light in the “dark zone”, is a design choice (see hereafter the simulation results). Similarly, various optical elements may be added to the design, for example, an optical stop or diaphragm (FIG. 1b) to improve the performance of the device (e.g., its contrast). When a matrix modulation device 15 is employed to alter the original beam, the natural result is that the light energy passing through that portion of the matrix modulation device 15 will be angularly redistributed.

In another embodiment, the described above approach may be used to re-shape the light distribution in an angularly selective way, and, even, to obtain sharp edges (abruptly decreasing the light intensity in the periphery of the beam), which can create an impression of higher intensity and better beam quality.

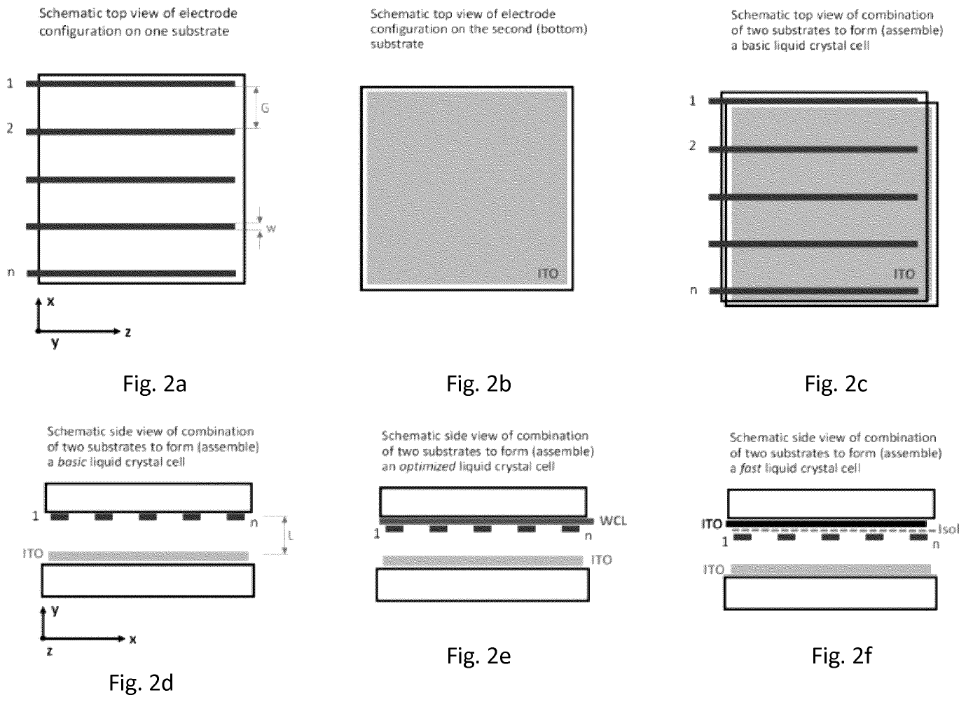

While modulator 15 can take many different forms (e.g., those described above), an example of an LC device using strip electrodes is illustrated in FIGS. 2a to 2f. FIG. 2a is a schematic top view of an electrode configuration on a first substrate. This first substrate can have individually controlled strip electrodes 1 through n of width w and a gap between them of G of the thickness L of the LC is chosen well to spread the electric potential in the desired optimal way. The strip electrodes can be deposited on the substrate, for example a glass or plastic substrate, and the electrodes can be transparent, for example made of indium tin oxide or ITO. An opposed second substrate can be provided with a uniform electrode, also for example made of ITO, as shown in FIG. 2b. In FIG. 2c the plan view superposition of the two substrates is shown.

FIG. 2d shows a side view of FIG. 2c looking in the Z direction. LC material can be filled between the two substrates. The LC material can have a ground state orientation, such as homeotropic (i.e. aligned to be perpendicular to the substrates) or planar (i.e. aligned parallel to substrates with a small pre-tilt angle from being parallel to the substrates), or a specific angle (between 0 and 90 degrees) with respect to cell substrates, and an alignment layer on the substrates in contact with the LC material can be provided for imparting to the LC material its ground state alignment.

FIG. 2e shows an embodiment in which a layer of weakly conductive material (WCL) is added near the strip electrodes. This WCL couples with the electric potential on the strip electrodes and acts to provide an electric potential profile across the gap G. This can allow the strip electrodes to create an electric field profile between the strip electrodes that can create a better optical quality to the lens, for example in the case illustrated the cylindrical lenses created by the strip electrodes.

FIG. 2f shows another embodiment in which a uniform electrode is added near the strip electrodes. An insulation layer separates the strip electrodes from the uniform electrode. This uniform electrode can be used to apply an electric field that “resets” the LC material, namely it can cause the LC to have a spatially uniform orientation that makes the LC layer uniform and transparent. For example, if the used LC is of “single frequency” and positive dielectric anisotropy, then the application of the potential difference between top and bottom uniform ITO electrodes may force the LC to quickly align uniformly and in the direction perpendicular to substrates. This will essentially “erase” the refractive index modulation. In contrast, when specific finger electrodes are activated only or in combination with the bottom uniform electrode only, then a lens like structure may be generated. Since the normal relaxation of the LC material into the ground state can take some time, the uniform electrode can allow for a faster operation. An equivalent situation may be considered if we use so called “dual-frequency” LC compositions.

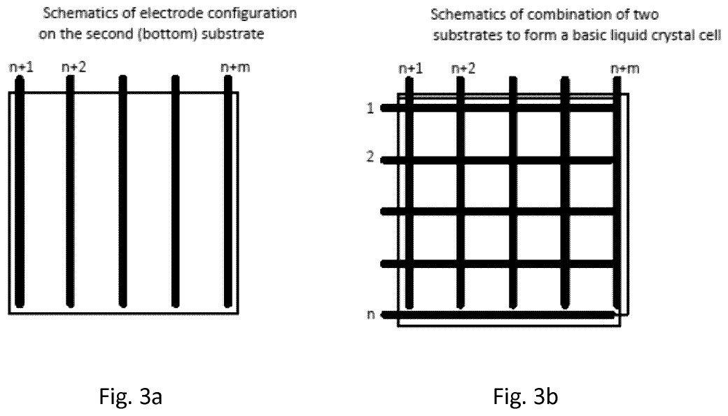

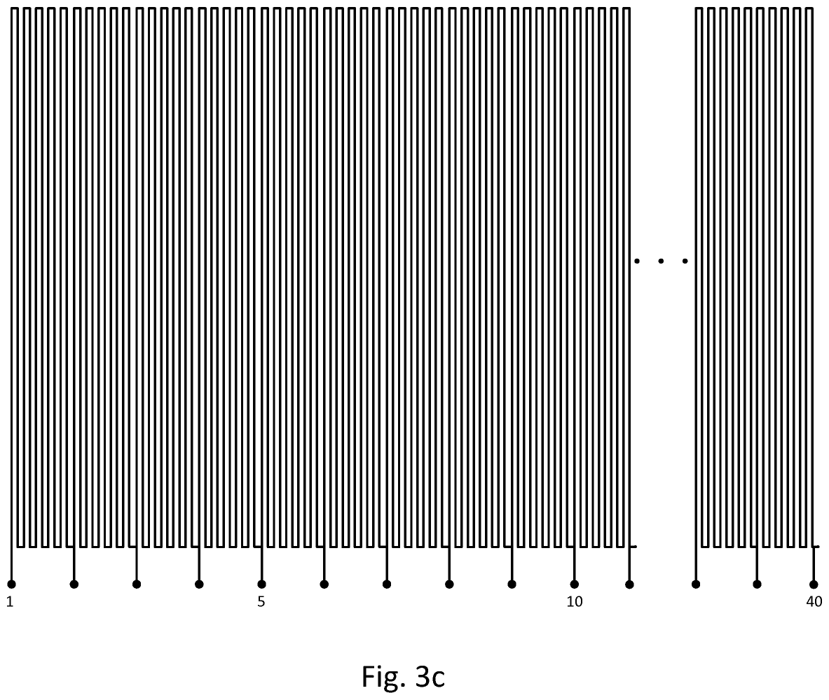

FIG. 3a is the same substrate and electrode disposition as FIG. 2a however, in FIG. 3b, it can be seen that the opposed substrate does not have a uniform electrode, but instead orthogonally arranged strip electrodes. These strip electrodes may have the same width and G arrangement as the electrodes shown in FIG. 3a.

A person skilled in the art will appreciate that without adding any uniform electrode, various light modulations are possible. If the LC material has a homeotropic ground state, the electrodes on either substrate can be powered to provide a cylindrical lens using in-plane control. The orientation of the lens is determined by the choice of the electrodes to be powered. This mode of operation does not use the WCL, and the optical quality of the lens can be poor. The contrast of the dark zone can be somewhat reduced depending on the optical arrangement.

With planar ground state orientation or homeotropic orientation of the LC material, the arrangement can be enhanced by adding uniform electrodes, so that the opposed uniform electrode can be used to provide a suitable electric field for creating cylindrical lenses. In some embodiments, the opposed uniform electrodes can be segmented into wide strips spanning the gap G of the opposed electrodes. When the segmented wide strips are all powered together, they will also act as a uniform electrode for improving speed of operation.

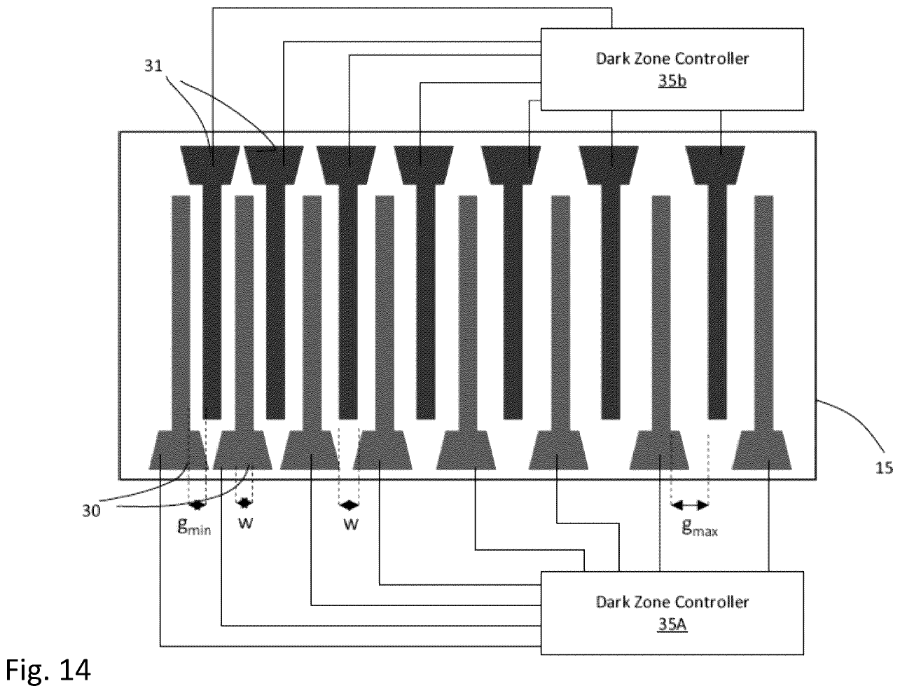

In some embodiments, a serpentine electrode structure for the LC device may be used, such that electrode contact points are driven by a signal to form a lens in an electrode matrix (which may include a total of about 60 or 80 connection nodes, each spaced at around 1 mm instead of each 0.1 mm) with an electric field spatial modulation controller may be significantly superior. This is illustrated in FIG. 3c for a serpentine electrode array that can provide a vertical cylindrical lens arrangement by selectively powering contact points. The serpentine of ITO electrode between the contact points provides a voltage drop between the contact points to provide for the desired liquid crystal orientation spatial modulation to form a cylindrical lens. As a matter of fact, this electrode architecture significantly reduces the number of control signals required to be provided to the device (see also the embodiment of FIG. 14). In this example, a cylindrical lens can be between 2 mm wide to about 6 mm wide. Multiple cylindrical lenses can be activated, if desired, to cover a larger portion of the aperture. The serpentine electrode structure can be oriented horizontally or in any region of the field of view or aperture.

While the serpentine electrode structure alone may achieve a spatial distribution of the electric field sufficient to create a lens at the desired location, a high dielectric material coating may be added over the electrode network, such as to smooth the electric field. The high dielectric constant material layer can comprise, for example, a layer of Ti3O5 100 nm thick having a dielectric constant of about 20 or more. An alternative “smoothening” effect can be obtained also if phase-shifted signals are applied to the opposed edges of these discrete node electrodes. The combination of both approaches can be beneficial.

It will be appreciated that the control of the profile of the electric potential by the driving signals provided to the serpentine electrode structures as presented in FIG. 3c, whether inside or outside the desired lensing zone, may be improved by activating other contacts (i.e. the contacts outside of the ones delimiting the lensing zone) instead of keeping them as floating. Additionally, the “phase relations” between the activated contact electrodes may be changed to adjust the profile (thus it may not be necessary to keep them all 90 degrees shifted one with respect to the other).

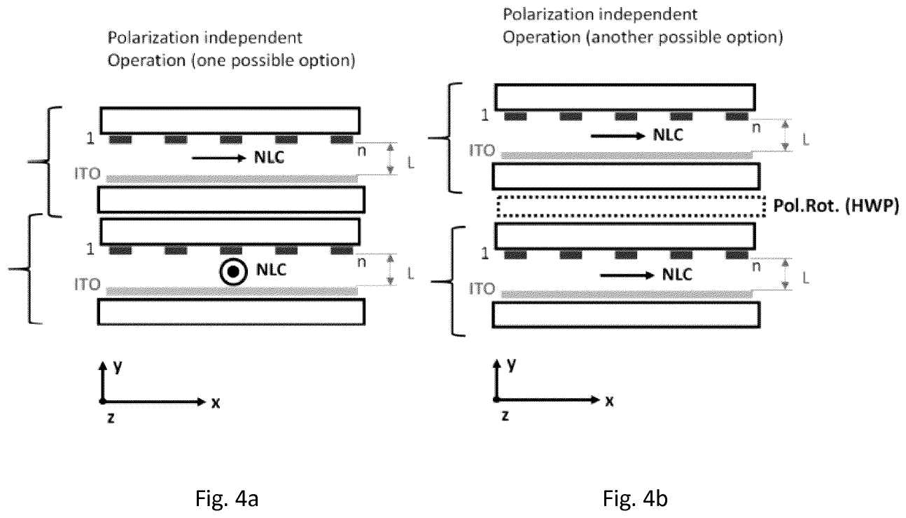

It is well known that often the natural or artificial light is unpolarized (that is, may be presented as a sum of two orthogonal polarized light components). Due to the nature of some LC materials (e.g., nematic LCs, or NLCs), light must be polarized since the LC modulator may act on only one (usually, extraordinary) polarization. However, the use of a polarizer (as it is done in traditional display industry) is highly undesired due to the loss of energy, increase of cost and reliability degradation. FIG. 4a illustrates an embodiment in which two LC modulators are combined to act on both linear (orthogonal) polarizations of light, one after the other. The top modulator has its ground state NLC molecules oriented, for example, perpendicular to its stripe electrodes (in some cases, it may be preferable to use an orientation at 450 with respect to these stripes). In the same time, the bottom cell has a similar electrode configuration, but the NLC molecules are perpendicular with respect to the top modulator. Thus, they are parallel to the stripes of the bottom modulator. With this arrangement, the combined modulator can act on unpolarized light having a mixture of two orthogonal polarizations. However, the operation of the device risk to be slightly asymmetric (not the same for these polarization components). FIG. 4b illustrates an embodiment in which two identical LC modulators are combined to act on both linear polarization components of light, however a polarization rotation element (a twisted NLC cell or half wave plate) is placed between the two modulators while the orientation of the electrodes and of NLC molecules are the same for the top and the bottom modulators. It is worth mentioning that multiple such devices can be assembled together allowing the light modulation in various plans.

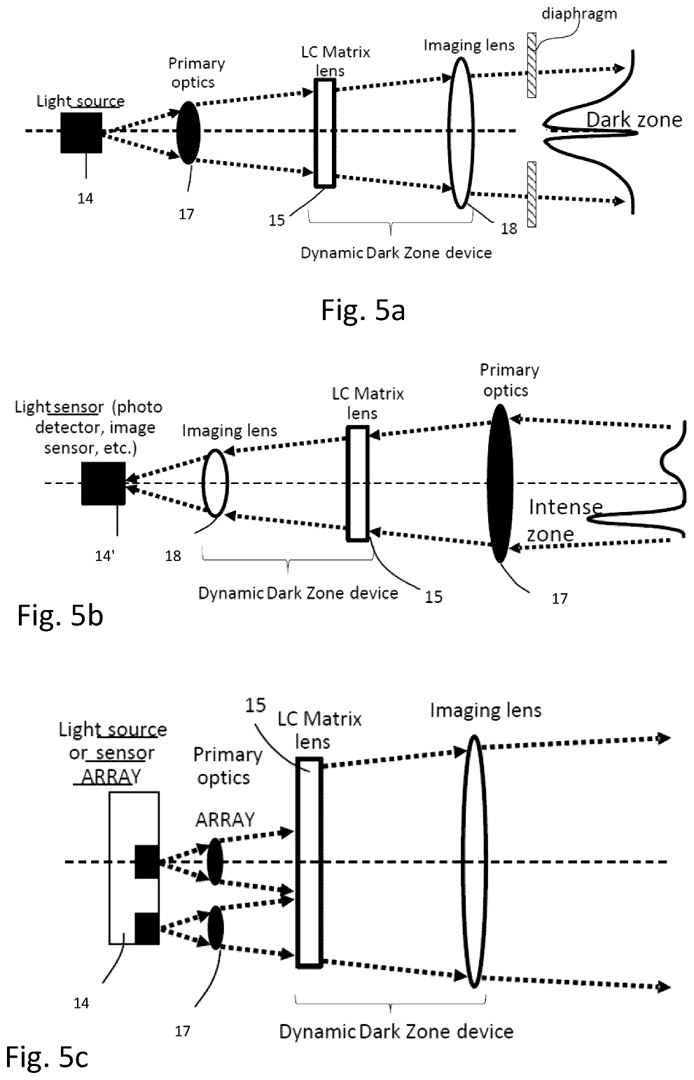

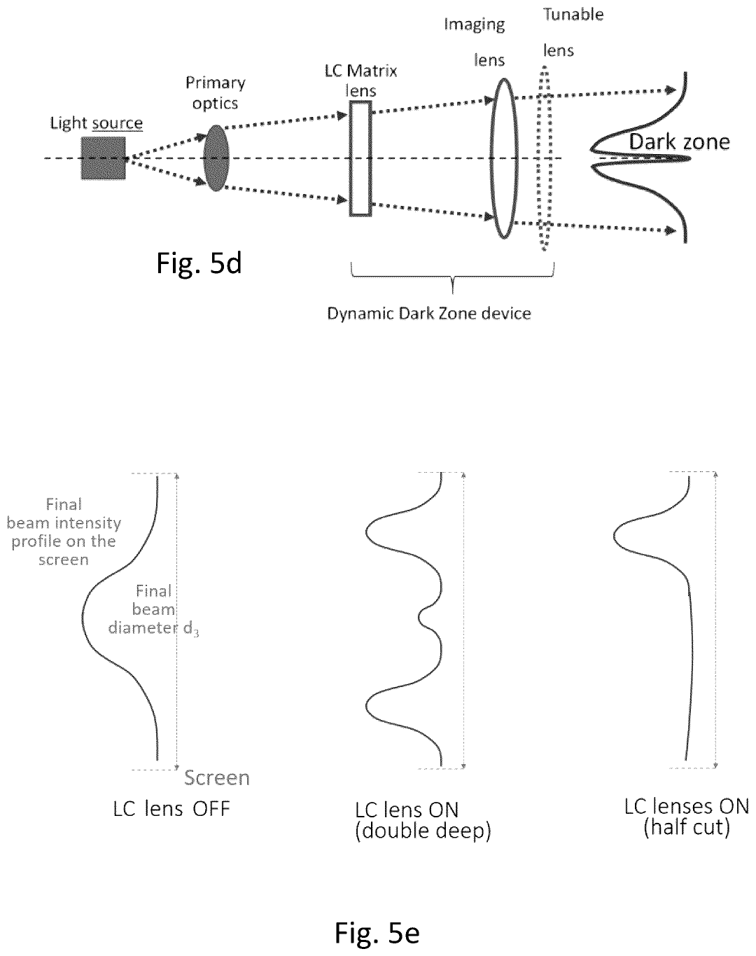

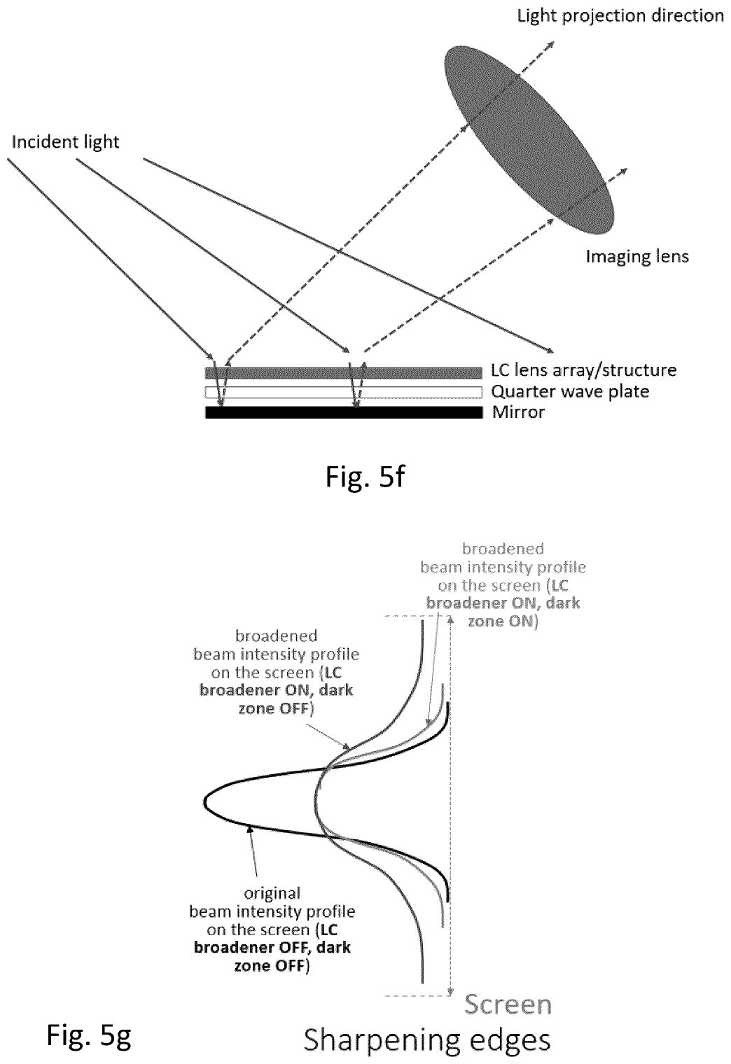

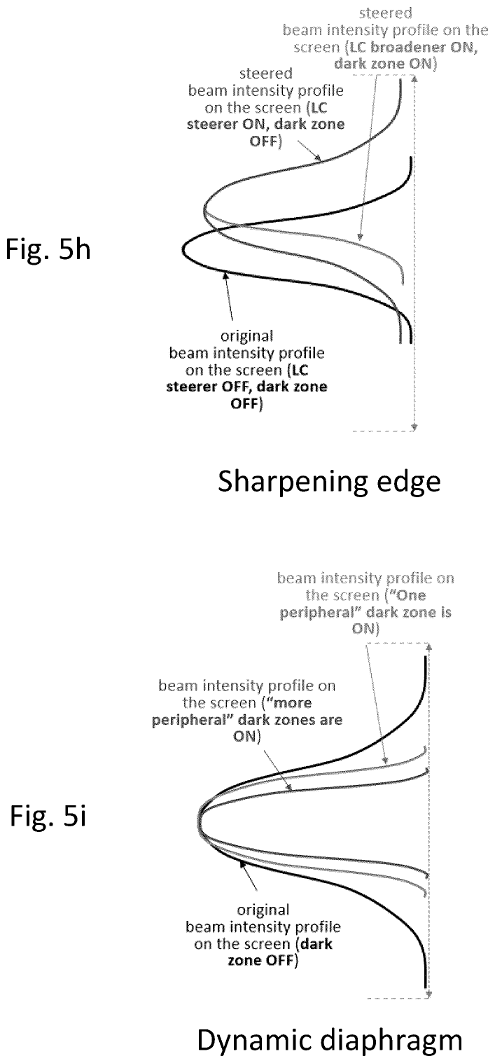

FIG. 5a shows an optical arrangement having a light source 14 coupled with primary optics 17 that produce a beam passing through LC matrix modulator 15 (from left to right). The beam continues through a lens 18 to be projected. As illustrated, the device 15 can be controlled to create a “dark zone” at a desired direction or location at the screen within the spot beam by activating the desired portion or region within the LC device 15 to divert light. As previously mentioned, the light source 14 may not require separate optics for producing the source beam, and the lens 18 may be of various characteristics depending upon the application.

It will be appreciated that the use of the matrix modulator allows for a creation of a dark zone without needing to resort to a light source comprising micro LED elements that are multiplexed to provide a beam with the ability to control the spatial distribution of the light beam.

FIG. 5b illustrates another embodiment in which the optical arrangement is used to receive (to detect) a beam rather than to project one. In this embodiment, the scene being imaged (here, light propagates from right to left) has an undesired intense zone (bright spot) that is not of interest for the image to be acquired. Collecting the image with the bright spot included can adversely affect image collection, for example due to saturation, reflections, damage to the sensitive image sensor or detrimental automatic gain control (AGC) in the image acquisition that would result in the region of interest away from the bright spot being too dark and thus difficult to analyse. It will be appreciated that the embodiments described herein that relate to modulation of a projected beam can equally be applied to beam recording and sensing. Thus, we can attenuate light coming from that direction and improve the quality of the recording for the rest of the scene. This technique can be used as in ordinary photography as well as in LIDARS and other sensing applications.

FIG. 5c illustrates an embodiment in which the proposed device can be used with an array of light sources or sensors 14. This array of sources or sensors can be optionally associated with an array of primary optics 17 (collimating the outcoming beam from individual sources or focusing the incoming light in into individual sensors). With the use of the spatial control offered by the matrix device 15, the operation of the array 14 can be significantly enhanced. For example, in addition to the creation of dark zones (as described above), we can also steer individual units into the same direction or divert them into various directions, or we can stretch light in one (e.g., vertical) or other (horizontal) directions by generating cylindrical lenses inside the matrix device, etc. We can also use the device as a block without having to perform spatial modulation control within 14, etc.

The dark zone LC device, which may combine an LC lens with an imaging lens, may further be used with any electrically tunable LC devices (e.g., light broadening, light steering, etc.) to additionally reshape the intensity distribution of light. FIG. 5d illustrates one such embodiment combining a tunable lens with a dark zone LC device. By changing the optical power of the tunable lens, additional control over the dark zone properties is made possible. In the case of a narrow beam, such a tunable lens may be used to focus light. Most often, it can/should be positioned just after the primary optics. In the case if we wish to use it behind the matric lens, very often the beam diameter will be large, and the tunable lens may be an array of micro lenses. In this case, it can provide additional broadening angle. In all these cases, the projected beam's shape and form may be thus controlled additionally.

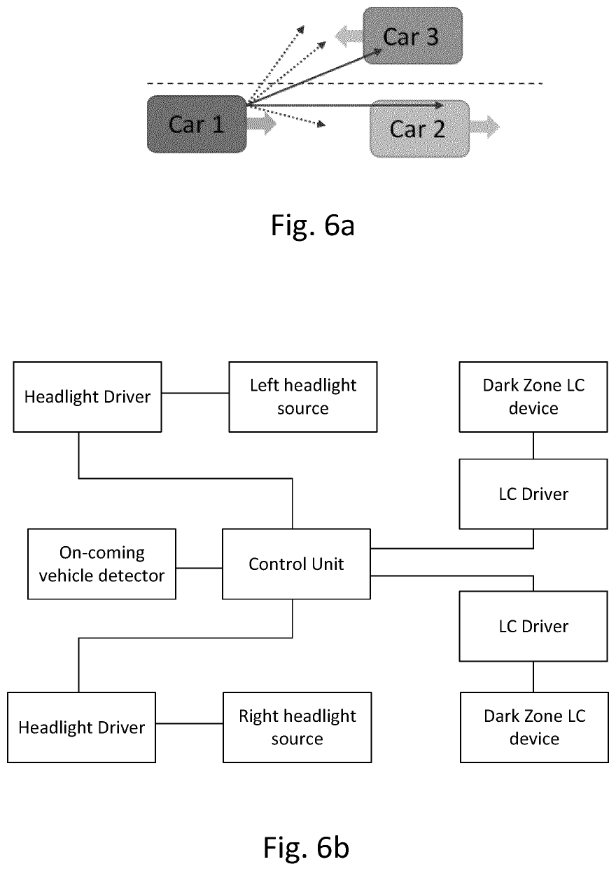

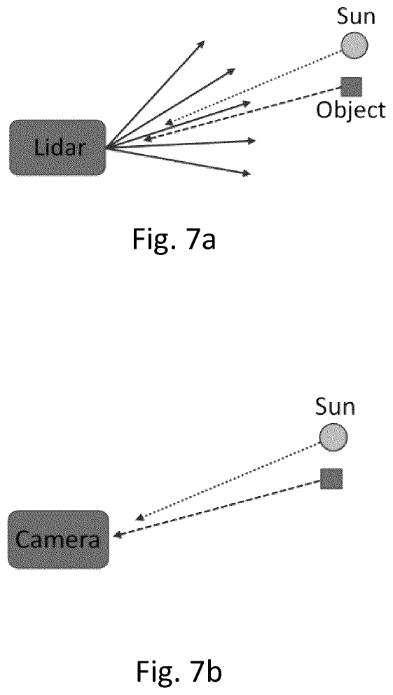

Examples of applications for the embodiments of FIGS. 5a through 5d are shown in FIGS. 6a to 7b. FIG. 5e is a composite illustration of complex light intensity distributions that may result from the use of an LC device as presented in FIGS. 5a to 5d. The examples illustrated in FIG. 5e shows some of the effects of the key parameters of the LC lens device and device may have on the light from a light source. By modifying at least one of the original divergence angle of the light provided to the tunable LC lens device, the parameters of the tunable LC lens device, the parameters of the imaging lens, the distances between the different elements of the optical system (e.g. distance between the LC matrix lens and the imaging lens), multiple variations in the light intensity distribution may be produced. While sharper borders or dark zones (e.g. “craters” in the intensity distribution) may be produced, more complex shapes may also be produced (see e.g. double deep shape in FIG. 5e).

In another embodiment, as illustrated in FIG. 5f, a combination of a tunable mirror lens device and an imaging lens may be used to create dark zone LC device and to perform focusing, lighting and light patterning functions with a single LC layer. As is known in the prior art, an LC lens including a quarter wave plate (with an optical axis that is tilted at 45° with respect to the ground state molecular orientation of the LC structure) and a mirror may be operable to act on both polarization of the incident light being provided to the LC mirror device. Depending on the LC lens structure layer over the quarter wave plate and mirror, the resulting light may be steered and/or broadened towards a desired direction. For example, the light may be redirected towards an imaging lens to create a light pattern, similarly to the embodiments of FIGS. 5a to 5d.

FIGS. 5g to 5i illustrates various exemplary light intensity distributions for dark zone LC devices in combination with a tunable beam broadening device, a beam steering device and a Fresnel lens. When used in combination with a beam broadening or steering device, the dark zone device may be used to sharpen the edges of the light intensity distribution.

This may be particularly useful in application where, for example, it is required to broaden light while having abrupt (sharp) edges, or in application in which light can be steered and there may be a need to additionally sharpen some of the corners. In some embodiments, it may be useful to create a tunable diaphragm, for example by activating one or more circular zone segments of Fresnel-similar LC lenses.

FIG. 5i illustrates one such embodiment of dynamic diaphragming in which a dark zone LC device is fabricated by using a Fresnel lens, combined with an imaging lens. In this exemplary light intensity distribution of the dynamic diaphragming, selectively activating various segments of the LC Fresnel lens may allow to sharpen desired edges and therefore control the width of the light intensity distribution. We can also activate various discrete segments of the Fresnel lens to create annular light distribution.

A person skilled in the art will appreciate that all LC lens devices described may be in the form of arrays of micro lenses due to the quadratic decrease of the optical power of an LC lens with any increase of the diameter of the lens. As such and for example, light broadening may necessitate the use of an array of micro lenses, which act as micro diffusors. Using such arrays of micro lenses generally results in the “softening” of illumination spot (in which edges become very smooth), and thus the use of the dark zone LC device, to sharpen the edges, may be particularly useful to counteract the softening effect.

In FIG. 6a, there is illustrated an application in which the headlight of a vehicle, car 1, can be modulated using device 15. When another vehicle, car 2, is detected to be in front of the car 1 (moving approximately in the same direction), an upper horizontal strip-like portion of the headlight beam (of the car 1) can be darkened to reduce the brightness of the headlight shining into the rear window and mirrors of car 2. Similarly, when another vehicle, car 3, is detected to be moving in the opposite direction to car 1, another vertical side strip-like portion of the headlight beam can be darkened to reduce the brightness of the headlight shining into the windshield of the opposing vehicle. The angular positions and other characteristics (such as depth and width of modulation) of these dark windows may be dynamically adjusted as the relative position of cars changes.

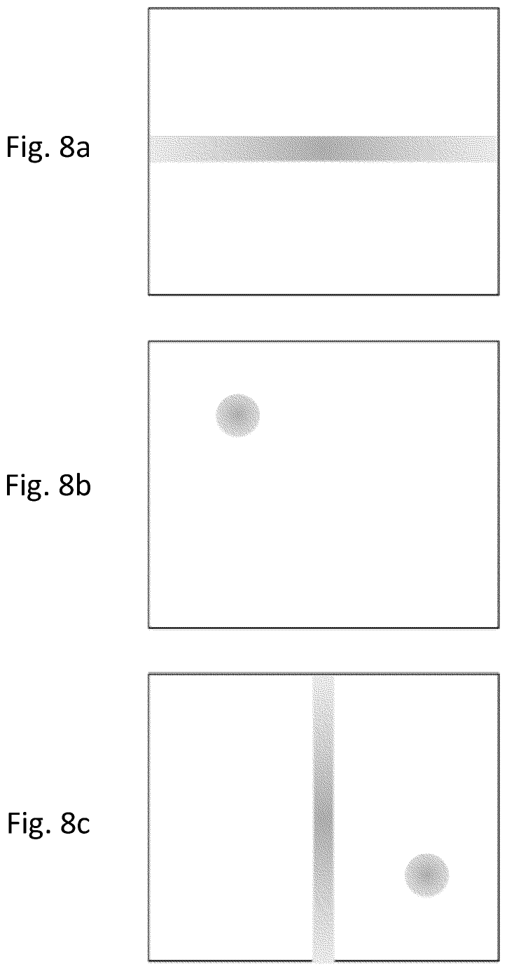

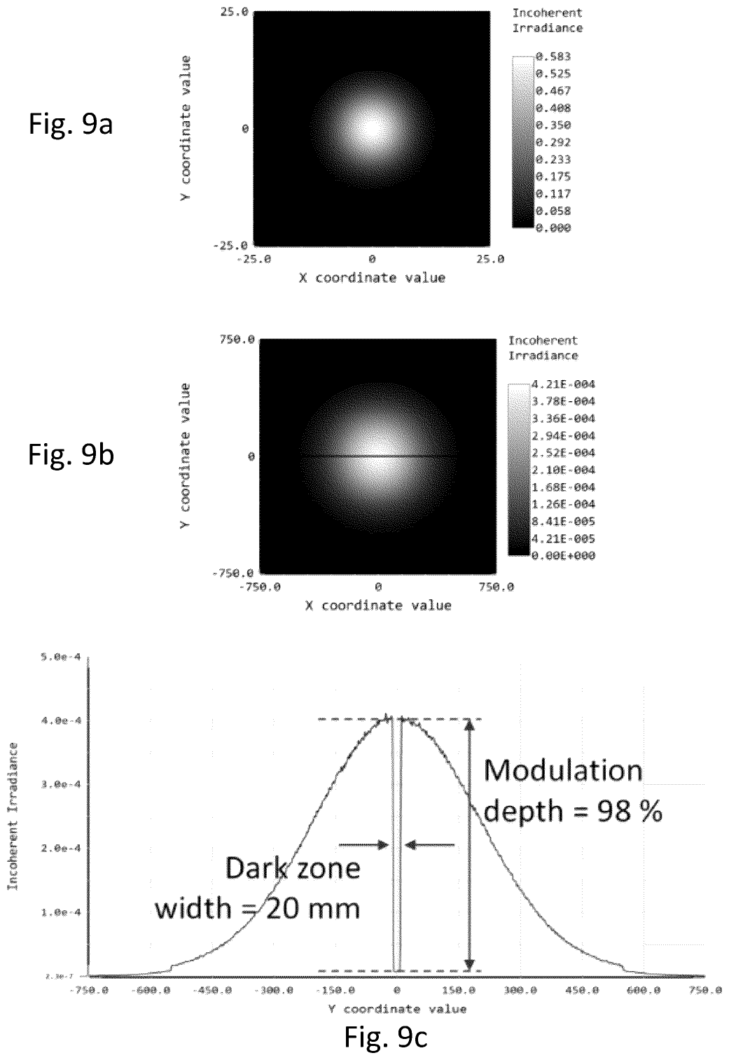

In some embodiments, the LC device used for the car's headlight may have multiple regions with different electrode structures over the area of the headlight. For example, regions at a top of the headlight and to the outer part of the headlight (i.e. right part for the passenger's side headlight and left part for the driver's side headlight, in a left-hand side driving vehicle). For example, the serpentine electrode structures may be non-continuous over certain regions, such as using electrode structures presented in FIGS. 8c, 8d and 9b. In the headlight application, the LC device may not cover all regions over the high and low beams. As a matter of fact, a lower and middle region of the headlights may never be problematic in terms of blinding a driver from a second vehicle. As such, the LC device may only be operative to affect a light in its upper and outer regions and thus limit the number of electrode contact point required to be driven by an electrical signal.

A person skilled in the art will appreciate that the light source affected in a specific region by the LC device, such as not to illuminate a driver or passenger from a second vehicle, may be steered or broadened (i.e. creation of a dark zone). While the dark zone will be further described herein, the light steering may be equivalently applicable and similarly implemented. For example, a horizontal region in the top section of a vehicle's headlight may be affected to reduce the potential blinding of a second vehicle's occupants, either by broadening the region or by steering the light in the region towards a non-blinding zone (e.g. towards the bottom). If steered towards the bottom, the light from the light source may be further useful for the vehicle's driver as the road in front of the vehicle may be illuminated at a higher light intensity.

FIG. 6b illustrates a schematic block diagram of an exemplary vehicle headlight control system equipped with dark zone LC devices, such as described in FIG. 6a. A control unit may receive information about on-coming vehicles from a detector (e.g. any type of sensor, such as image sensor, light sensor, RADAR, LIDAR, etc.) and perform the required calculations to ascertain, when required, the location and properties of the dark zone(s) that should be created to reduce the headlight beam portion that could affect the driver of the other vehicles. It will be appreciated that the on-coming vehicle detector may equivalently detect vehicles that are on-going, such as vehicles moving the same direction as the vehicle equipped with the system described herein. The control unit may be operable to control the headlight drivers for both headlights (e.g. on, off, low-beam, high-beam, etc.) as well as control the dark zone LC device drivers of each headlight. The LC device drives may thus power the required electrodes of the dark zone LC devices, such that the desired dark zone is created.

A person skilled in the art will appreciate that the dark zone LC devices may be located in front of the vehicle's headlight, such that the headlight source, when controlled to output light, will pass through the LC device.

In FIG. 7a, a LIDAR system is illustrated whose optical arrangement includes device 15. By dynamically activating the portion of the device 15 corresponding to the scene in which a bright object is found, such as the sun, the dark zone created can prevent the influence of the bright spot on the LIDAR system. Similarly, in the case of FIG. 7b, device 15 is used to darken the sun in the camera image. In the case of a camera, it may be desirable to arrange device 15 within the camera optics so that the dynamic redirection of light within the selected portion of the beam causes the redirected light to be outside the stop or diaphragm and thus not introduce any background noise in the rest of the image.

FIGS. 8a to 8c schematically illustrate the formation of a horizontal dark line alone, a dark spot alone or the combination (simultaneous formation) of a dark spot with a dark (vertical) line. In FIG. 8a, can be obtained by using a subset of the electrodes in one direction (horizontal), powered in the specific area of the device 15 (to form a single cylindrical lens). In the case of FIG. 8b, subsets of the strip electrodes in orthogonal directions are powered (with specific phase shifts for electrodes at various substrates) to produce a small square-like region in which a single circular lens appears. As illustrated in FIG. 8c, more than one lens can be created within the aperture of device 15, either by having separated electrodes for different portions of the aperture, or by time-multiplexing the powering of electrode arrays for the plural lenses.

FIGS. 9a to 9c illustrate simulation results. Non sequential Zemax simulations were used to demonstrate the operation of the proposed device 15. An example of experimental parameters is presented in the Table 1:

| Parameter | Value | |
|---|---|---|
| Source FWHM | 6 | deg. |
| Lenslet diameter | 0.5 | mm |
| Active lenslet focal length | 0.5 | mm |
| Source to lenslet array distance | 100 | mm |
| Lenslet array to imaging lens distance | 80 | mm |
| Imaging lens focal length | 100 | mm |
| Imaging lens to screen distance | 5.0 | m |

The light intensity distributions as simulated are shown at the position of the matrix lens, FIG. 9a, at the screen, FIG. 9b, and the corresponding intensity distribution, FIG. 9c for the case of activation of a cylindrical miniature lens (like the one shown in FIG. 8a) in the matrix lens array 15. As can be seen, a significant intensity modulation depth of 98% can be achieved in this embodiment at the center of the beam.

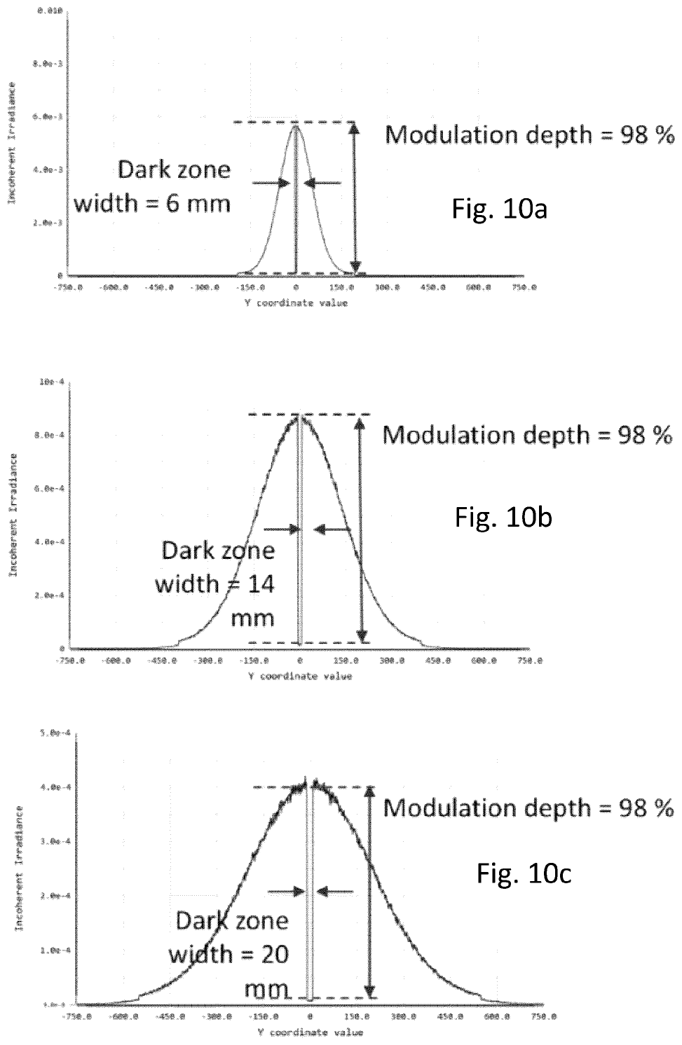

FIGS. 10a to 10c illustrate the simulated beam intensity in the Y axis at screen distances of 1.5 m, 3.5 m and 5.0 m respectively for the same simulation parameters (presented in the Table 1). These simulations show that the width of the generated dark zone scales with distance, while the modulation depth is preserved. This can be taken into account when designing the specific application.

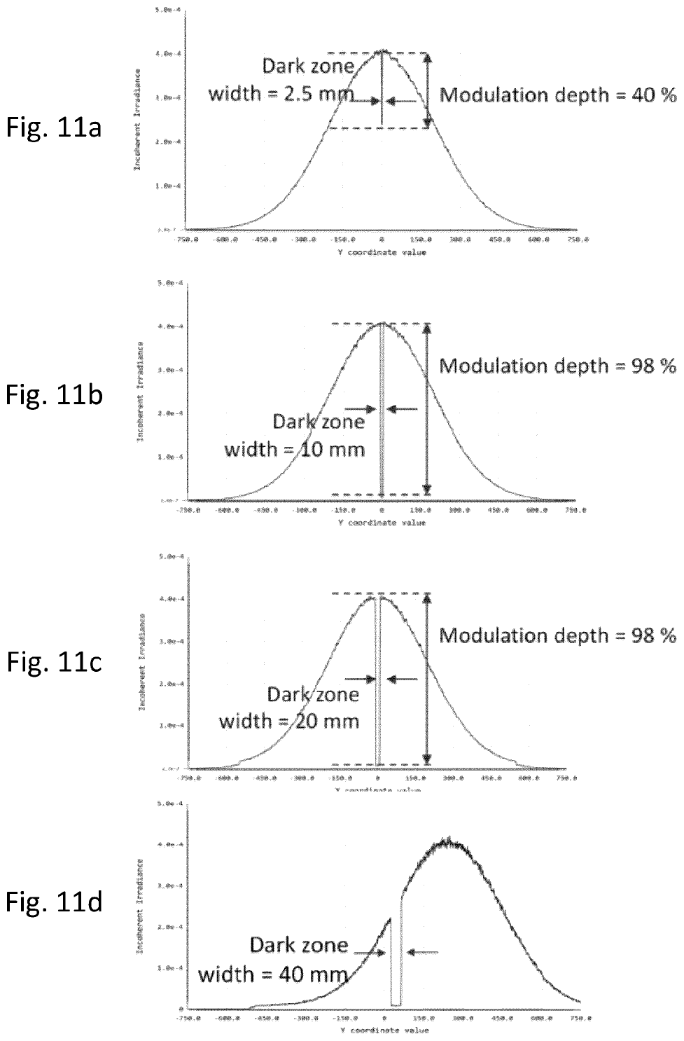

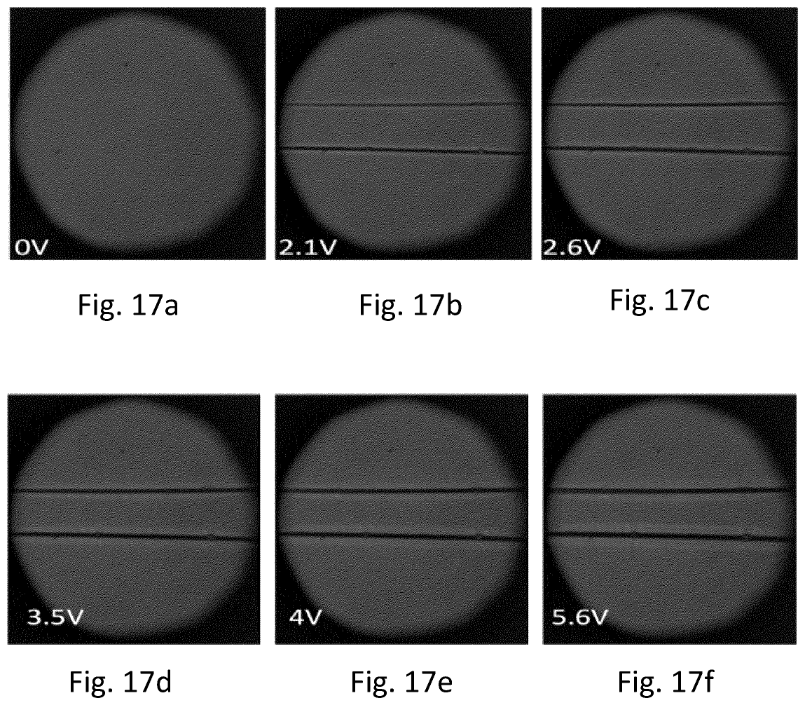

FIGS. 11a to 11d show how the choice of the diameter (0.05 mm, 0.25 mm and 0.5 mm for FIGS. 17A to 17C respectively) of the activated cylindrical microlens of the matrix lens 15 for the same simulation parameters (presented in the Table 1) affects both the width of the generated dark zone scales as well as the modulation depth. This choice can be made by designing the corresponding electrodes (of the matrix lens 15) or by activating multiple micro lenses at the same time. Thus, FIG. 11d shows such an example (same parameters as in Table 1), when two neighboring microlens arrays are activated simultaneously (providing even greater width of the dark zone).

FIGS. 11a to 11d show how the choice of the diameter (0.05 mm, 0.25 mm and 0.5 mm for FIGS. 11a to 11c respectively) of the activated cylindrical microlens of the matrix lens 15 for the same simulation parameters (presented in the Table 1) affects both the width of the generated dark zone scales as well as the modulation depth. This choice can be made by designing the corresponding electrodes (of the matrix lens 15) or by activating multiple micro lenses at the same time. Thus, FIG. 11d shows such an example (same parameters as in Table 1), when two neighboring microlens arrays are activated simultaneously (providing even greater width of the dark zone).

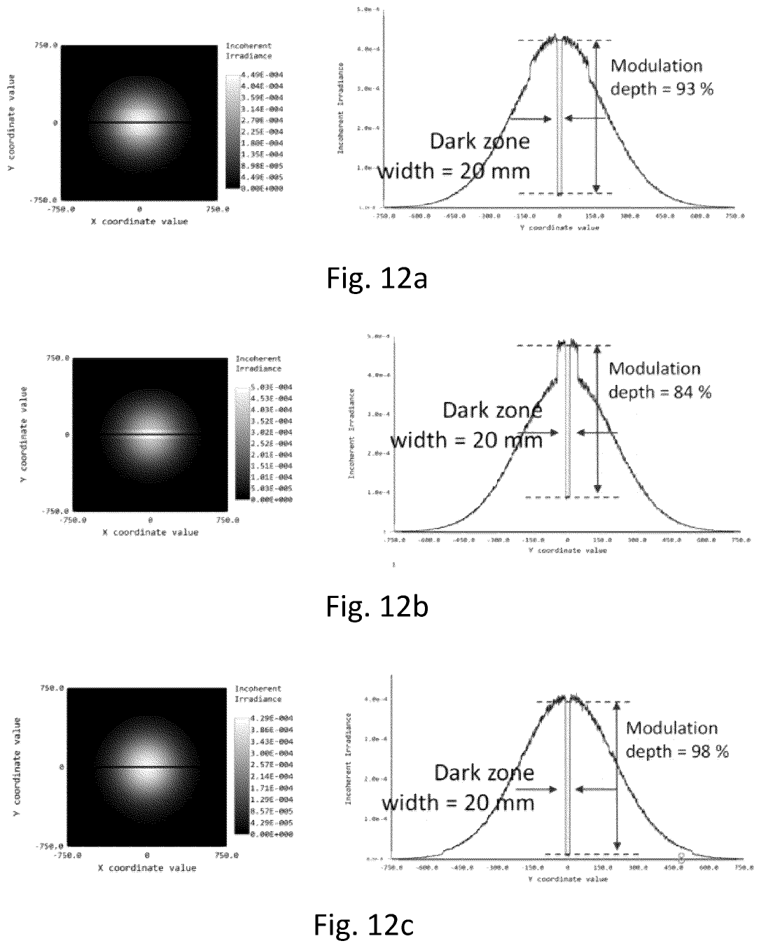

FIGS. 12a to 12c illustrate on the left side the beam intensity image and on the right side the corresponding beam intensity along the Y axis for the case of the focal distance of the microlens chosen to be −2.0 mm, −5.0 mm and −0.5 mm, respectively. The most interesting case, of course, is the dynamic change of the focal distance of the microlens (since we can continuously change it or switch it ON and OFF). Some examples (using the same simulation parameters, presented in the Table 1) of obtained intensity distributions are shown on the right side of FIGS. 12a to 12c, when the focal distance of the microlens is changed. In this way, for example, not only can we create an intensity depression (FIG. 12c), but also, we can generate different types of light redistribution (FIGS. 12a and 12b).

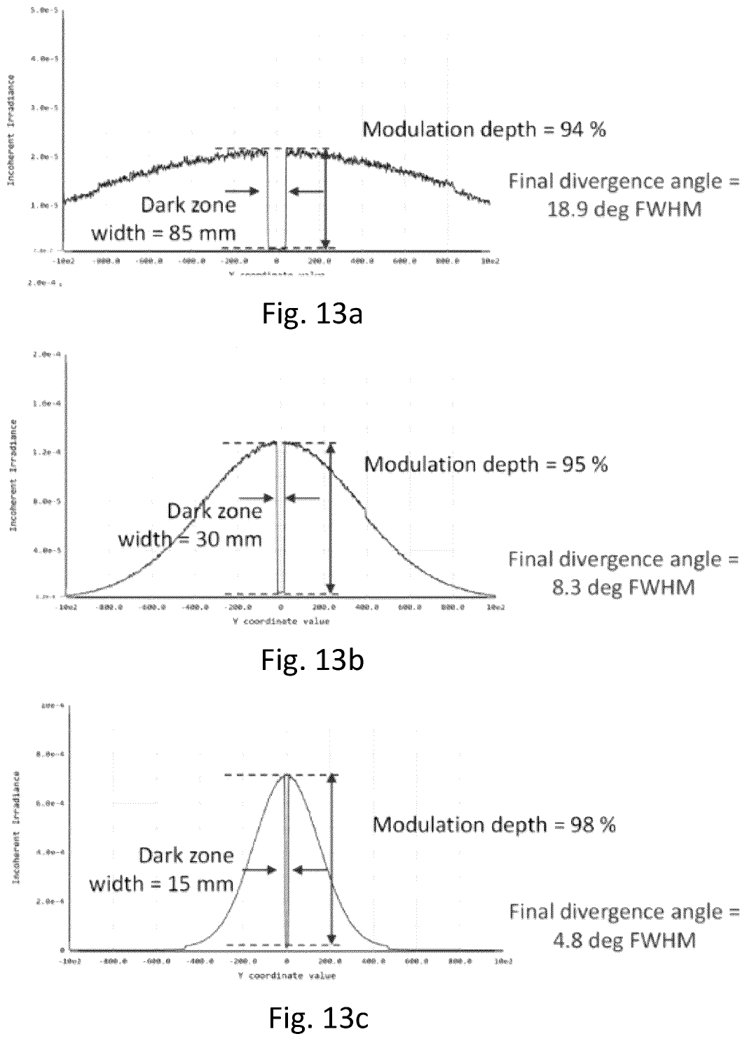

In some embodiments, the optical arrangement 10 can have extra ordinarily large choice of functionalities. For example, by the choice of the focal distance (e.g., −50 mm, 50 mm and 75 mm) of the imaging lens 18 (or we can also chose to have an imaging lens with tunable focal distance) we can further modify the light distribution pattern as demonstrated in FIGS. 13a to 13c for the imaging lens focal length of −50 mm, 50 mm and 75 mm, respectively, for the physical parameter values presented in Table 2:

| Parameter | Value | |
|---|---|---|
| Source FWHM | 6 | deg. |
| Lenslet diameter | 0.5 | mm |
| Active lenslet focal length | 2.0 | mm |
| Source to lenslet array distance | 100 | mm |
| Lenslet array to imaging lens distance | 20 | mm |
| Imaging lens focal length | variable | |
| Imaging lens to screen distance | 5.0 | m |

To confirm experimentally the above-mentioned predictions, we have built a simple matrix lens 15 of one dimension (1D), that can generate cylindrical lenses of different diameters, but all in one direction (say, vertical, see the schematic diagram of FIG. 14. One of the cell substrates is covered by a uniform indium tin oxide (ITO) electrode, while the second one has individually controlled “finger” type (or interdigitated) electrode pairs (30 and 31).

In this embodiment, a controller 35a is connected to each electrode 30, while a separate controller 35b is connected to each electrode 31. Such a controller 35 can be a single controller if desired. It comprises switches for selectively powering the individual electrodes. The input to such a controller can be data signals, as for example a serial input for a scan chain control. Since the electrodes can comprise any spatially controllable electrode array having any desired geometry, the controller 35 can likewise be adapted for the type of electrode array.

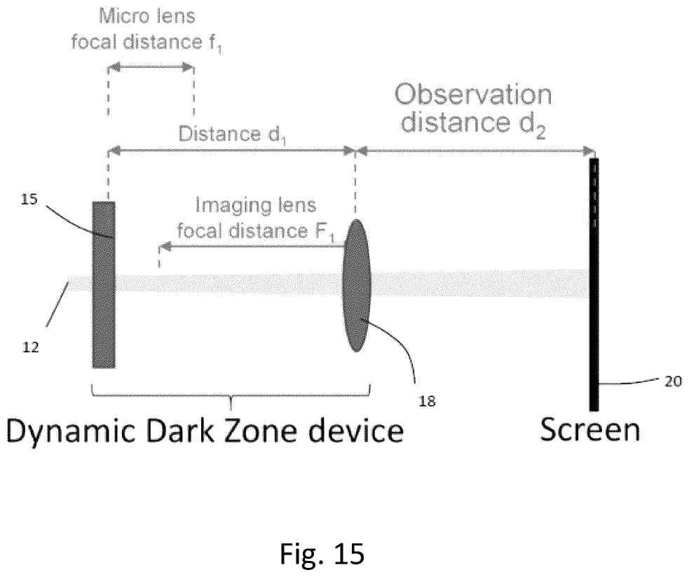

The width of the ITO electrodes is w=10 μm. The distance of the first pair (on the left) of the electrodes gₘᵢₙ=50 μm and increases by 10 μm increment. Thus, the distance of the last pair (on the right) of electrodes is gₘₐₓ=170 μm. The working zone is shown by the rectangle. Different driving techniques may be applied, for example, we can activate one of the finger electrodes while all others 9 including the uniform ITO) are grounded. The experimental parameters were: homeotropic aligned ceLC (NLC6028) ll gap=40 μm (optical birefringence Δn=0.2); f₁ of lens 18 (see FIG. 15) is electrically tunable, F₁=10.5 cm, d₁≈10 cm and d₂=variable during the experiment (see below). The original beam's 12 divergence angle is 1.5°.

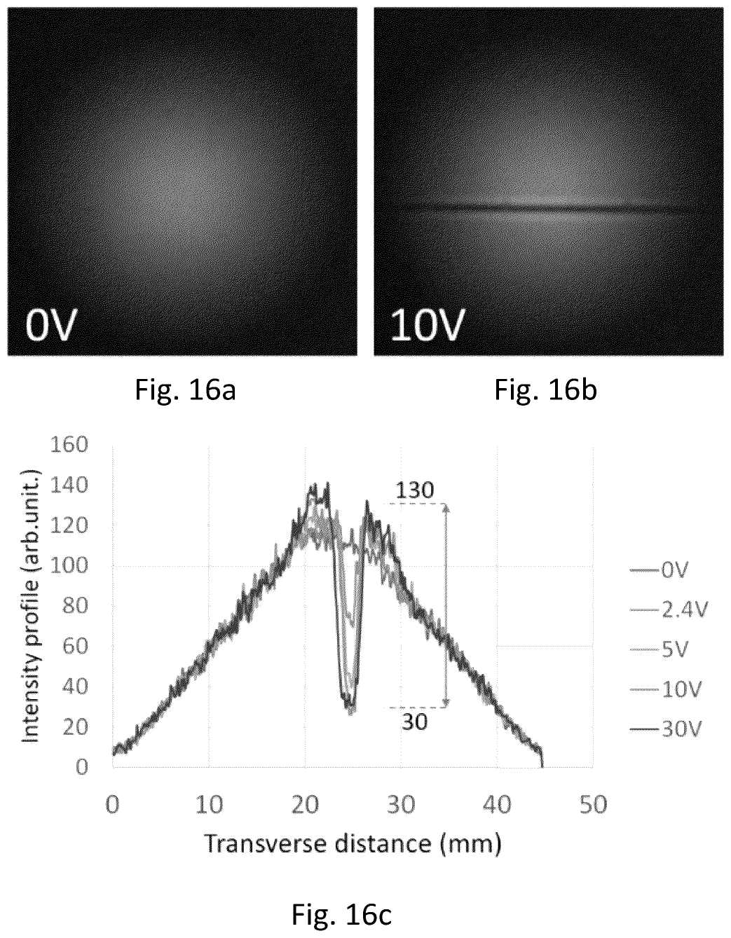

FIG. 16a shows the image of the transmitted beam in the ground state (0V), while FIG. 16b shows the image of the beam at 10V. FIG. 16c shows the intensity distribution across the beam on the screen vs applied voltage. (the screen is located at d₂=130 cm far from the imaging lens). As we can see, the modulation depth is approximately 77% and it can be dynamically tuned.

FIGS. 17a to 17f show images using two simultaneously generated cylindrical micro lenses that generate two dark zones in corresponding angular zones, for example, to avoid exposing the drivers of co-propagating (exposure via the mirror) and counter propagating (direct exposure) cars (see FIG. 6a). One of these dark windows may be more or less in the same angle (for the co-propagating car), while the second one (for the counter-propagating car) may be shifted dynamically.

1. A liquid crystal optical device for controllably obscuring a portion of a field of view without light absorption, the device comprising:
an electrode array having distinct spatially arranged electrodes for controlling liquid crystal orientation differently at different locations over an aperture of said device,
wherein when said electrode array is operative to cause said device to change from a transparent uniform state to a transparent nonuniform state diverting light state at said different locations over an aperture of said device; and
a controller connected to said electrode array configured to switch power to said electrode array in accordance with an input signal selecting one or more given ones of said different locations over the aperture of said device.

2. The device as defined in claim 1, further comprising an optical element redirecting energy of the diverted light into different directions.

3. The device as defined in claim 1, wherein said device comprises at least one layer of liquidcrystal material and said electrode array is arranged to act on said at least one layer to focus light passing through the desired location in the transverse plane.

4. The device as defined in claim 1, wherein said electrode array comprises serpentine electrodes.

5. The device as defined in claim 1, wherein said controller is configured to switch power to more than one of said different locations over the aperture of said device.

6. The device as defined in claim 1, wherein the electrode array is configured to provide a segmented Fresnel lens or beam steering arrangement of the liquid crystal.

7. The device as defined in claims 1, comprising a mirror for reflecting light passing through the liquid crystal and a quarter wave plate that rotates the linear polarization of light by 90° after reflection by the mirror.

8. The device as defined in claim 1, comprising two similar liquid crystal cells assembled with 90° rotation of their ground state molecular orientations to provide polarization independent operation.

9. The device as defined in claim 1, further comprising a device to control edges of a passing through said device.

10. An optical arrangement for controllably obscuring a portion of a field of view, the arrangement comprising:
a liquid crystal optical device as defined in claim 1; and
an imaging lens.

11. A controllable light projector for producing a light beam with a controllable obscured portion of the light beam, the projector comprising:
a light source;
the optical arrangement as defined in claim 10.

12. A vehicle headlamp comprising a headlight source forming a headlight beam and a liquid crystal optical device as defined in of claim 1.

13. The vehicle headlamp as defined in claim 12, further comprising a control unit connected to said controller of said liquid crystal optical device.

14. The vehicle headlamp as defined in claim 13, further comprising a headlight driver, wherein said control unit is connected to said headlight driver to change an intensity of said headlight source.

15. The vehicle headlamp as defined in claim 14, further comprising an on-coming vehicle detector connected to said control unit, said control unit being responsive to said on-coming vehicle detector to control said controller of said liquid crystal optical device.

16. A light sensing or recording apparatus for sensing light from a field of view with a controllable obscured portion of the field of view, the apparatus comprising:
the optical arrangement as defined in claim 10; and
a light sensor operatively coupled to said optical arrangement for receiving light from said field of view.

17. A method for sensing light from a field of view, the method comprising:
optically collecting a beam of light from said field of view;
capturing said beam on an image sensor at an image plane;
measuring a brightness of light at different locations within said image plane;
determining which portion within said image plane requires obscuring; and
using a liquid crystal optical device for controllably obscuring said portion.

18. The method as defined in claim 17, wherein the liquid crystal optical device comprising:
an electrode array having distinct spatially arranged electrodes for controlling liquid crystal orientation differently at different locations over an aperture of said device,
wherein when said electrode array is operative to cause said device to change from a transparent uniform state to a transparent nonuniform state diverting light state at said different locations over an aperture of said device; and
a controller connected to said electrode array configured to switch power to said electrode array in accordance with an input signal selecting one or more given ones of said different locations over the aperture of said device.
